(19) United States
(12) Patent Application Publication
(10) Pub. No.: US 2006/0156075 A1
(43) Pub. Date: Jul. 13, 2006

(54) Semiconductor integrated circuit

(75) Inventor: Naoki Mitsuishi, Kodaira (JP)

Correspondence Address: MILES & STOCKBRIDGE PC, 1751 PINNACLE DRIVE, SUITE 500, MCLEAN, VA, 22102-3833, US

(73) Assignee: Renesas Technology Corp.

(21) Appl. No.: 11/299,971

(22) Filed: Dec. 13, 2005

(30) Foreign Application Priority Data
Dec. 14, 2004 (JP) 2004-361097

(51) Int. Cl. G06F 11/00

(52) U.S. Cl. 714/51

(57) ABSTRACT

Error recovery processing is performed to minimize the influence of malfunction when an error is detected. When an error occurs in a normal program execution state, control branches to a predetermined error handling routine shown by exceptional handling vectors or the like. While executing the instruction that writes zero to a timer counter in an interval not extending an overflow cycle, the error handling routine of a CPU performs processing for inhibiting a fatal operation in accordance with a control target system. An example of inhibiting a fatal operation is to deactivate output signals of a microcomputer. Upon completion of the error handling, the monitoring timer is stopped, and the processing of the CPU is changed to the normal reset processing routine.

### CROSS-REFERENCE TO RELATED APPLICATION

The present application claims priority from Japanese patent application No. 2004-361097 filed on Dec. 14, 2004, the content of which is hereby incorporated by reference into this application.

### BACKGROUND OF THE INVENTION

The present invention relates to an error handling technique of a semiconductor integrated circuit, and more particularly to a technique suitable to recovery processing for minimizing the influence of malfunction triggered by an unpredictable error.

A known single-chip microcomputer, which is one of semiconductor integrated circuits, has functional blocks such as ROM (Read Only Memory) for storing programs, RAM (Random Access Memory) for storing data, and input/output circuits for inputting and outputting data that are formed around a central processing unit (CPU) The functional blocks are formed on one semiconductor substrate (see Institute of Electronics and Communication Engineers of Japan, “LSI Handbook”, Ohm Inc., Nov. 30, 1984, P540, P541).

Some of such single-chip microcomputers execute illegal instruction exception handling when the CPU attempts to execute an undefined instruction as an instruction. The CPU performs required control in an illegal instruction exception handling routine.

The required control inhibits fatal operations of equipment controlled by the microcomputer. For example, when a motor is being controlled, the motor is stopped to prevent the equipment from falling into an unrecoverable state. After that, operation is resumed with a reset.

On the other hand, other microcomputers, which include a watchdog timer (WDT), determine that the CPU runs out of control when access to the watchdog timer by the CPU is not made for a specified period of time, request a nonmaskable interrupt (NMI) from the CPU, or generate a reset.

For the nonmaskable interrupt, the same control as for the above-described illegal instruction is performed. For a reset, the microcomputer itself is initialized, then operation is resumed with the reset.

This type of a microcomputer judges an instruction decoding result to detect a decoding error, and when detecting a decoding error, while holding the state to wait that the decoding error is resolved, counts the state, and generates a reset when a predetermined reference value is reached (see Japanese Unexamined Patent Publication No. 2001-273136). In short, a reset is generated when the error is not resolved within a predetermined time.

When a decoding error has been detected, since there is a possibility that an undetected error occurred previously, it is desirable to perform processing for the error instead of waiting that the detected error is resolved or removed.

A temporary error does not immediately lead to the inability of the CPU to perform error handling. An error does not always occur in only the CPU, an error does not always occur only once, and an error is not always detectable.

In the above-described example, even when a temporary error (an error resolved before a reference time is reached) occurs repeatedly, a reset is not requested and processing is continued.

With advances in microfabrication of semiconductor process, a potential for an error to occur increases. Possible causes of the error are electromagnetic waves and noises.

### SUMMARY OF THE INVENTION

It was found out by the inventors that the recovery processing technique at error detection in the above-described semiconductor integrated circuit has the following problem.

A microcomputer by nature could not execute illegal instruction codes during operation because it executes a debugged program. Specifically, an illegal instruction is executed when a legal instruction code (e.g., H′0000) changes to a different instruction code (e.g., H′1000) due to an undesired error such as noise.

Furthermore, when a result of changing to the different instruction code is an undefined instruction to the CPU, illegal instruction exception handling is executed. In other words, even when an instruction code changes, if the changed instruction code corresponds to a correct instruction code of the CPU, illegal instruction exception handling is not executed. The changed instruction code will be executed as it is.

Accordingly, when illegal instruction exception handling has been executed, it is conceivable that an instruction code changed previously and the changed instruction was executed without being detected as an illegal instruction, with the result that the microcomputer has not already been in a normal state. Likewise, not all noise-triggered errors occur in only the CPU.

For these reasons, the execution of exception handling by the CPU may be impeded. The term impede refers to repeated interrupt requests, continued wait request during bus access, and continued operation of other bus masters.

These events cannot be immediately judged as malfunction generally, but it cannot be said that these events take precedence over CPU error handling. In such cases, the microcomputer is initialized by a reset.

However, by the reset, processing corresponding to equipment controlled by the microcomputer may not be performed. For example, when a motor is being controlled, it may not be stopped in a correct procedure.

An object of the present invention is to provide a technique by which the influence of error-triggered malfunction can be significantly reduced by waiting for the execution of an exception handling routine (inhibits a fatal operation of equipment controlled by a semiconductor integrated circuit) by a central processing unit when an error is detected, and by issuing a reset when it is judged that the exception handling routine by the central processing unit is not executed.

The aforementioned and other objects of the invention and the novel features thereof will become apparent from the descriptions and accompanying drawings of this specification.

The typical disclosures of the invention will be described in brief as follows.

A semiconductor integrated circuit of the present invention comprises a central processing unit that detects an error, and branches to a predetermined processing routine, and a monitoring timer that starts to count based on an error detection signal when the central processing unit detects an error. The monitoring timer requests a reset upon judging that the central processing unit does not execute processing corresponding to the detected error.

The contents of the present invention will be described in more detail below.

A semiconductor integrated circuit according to the present invention comprises: a central processing unit that accepts exception handling (illegal instruction exception handling, address error, and nonmaskable interrupt request signal) when detecting an error, and can execute an exception handling routine; a monitoring timer that detects the exception handling, then performs transition to a proper state to monitor a processing state of the central processing unit, and requests a reset upon judging that the exception handling routine is not executed by the central processing unit; and a reset control block that resets the central processing unit and other partial or all functions of the semiconductor integrated circuit according to the reset request of the monitoring timer.

When detecting an error and performing transition to a proper state, the monitoring timer inhibits factors to impede error handling of the central processing unit. Specifically, it inhibits bus right requests of other bus masters, resets other bus masters, and inhibits interrupt requests.

Furthermore, the semiconductor integrated circuit includes logical blocks that detect errors. They detect access addresses by a bus controller, and detect execution of undefined instructions of the central processing unit.

The monitoring timer makes the above-described judgment by detecting that no access is made from the central processing unit within a given time. It is shared with a watchdog timer when no error is detected (user resource). The monitoring timer makes the above-described judgment by monitoring instruction execution states of the central processing unit. Instruction execution states of the central processing unit can be judged by an instruction execution end signal and other signals.

Effects obtained by typical disclosures of the invention will be described in brief as follows.

(1) When an error is detected, without immediately generating a reset, processing such as stop corresponding to equipment controlled by the semiconductor integrated circuit can be performed. Therefore, the reliability of the semiconductor integrated circuit can be significantly increased.

(2) Since a reset is generated when exception handling by a semiconductor integrated circuit is not performed because there is a factor to impede the operation of the semiconductor integrated circuit, the semiconductor integrated circuit can be restored without fail.

(3) According to the described (1) and (2), by forming an electronic system using the semiconductor integrated circuit, the reliability of the electronic system can be increased.

### BRIEF DESCRIPTION OF THE DRAWINGS

FIG. 1 is a block diagram of a microcomputer according to one embodiment of the present invention;

FIG. 2 is a block diagram of a CPU mounted in the microcomputer of FIG. 1;

FIG. 3 is an explanatory drawing showing an address space in the CPU shown in FIG. 2;

FIG. 4 is a block diagram showing the configuration of a monitoring timer mounted in the microcomputer of FIG. 1;

FIG. 5 is an explanatory drawing showing an example of the configurations of a timer control register in the monitoring timer of FIG. 4, and a timer counter register;

FIG. 6 is a drawing showing state transition in the monitoring timer of FIG. 4;

FIG. 7 is a timing chart in the monitoring timer of FIG. 4; and

FIG. 8 is an explanatory drawing showing an example of error handling in the microcomputer of FIG. 1.

### DETAILED DESCRIPTION OF THE PREFERRED EMBODIMENTS

Hereinafter, embodiments of the present invention will be described with reference to the accompanying drawings. In all drawings for describing the embodiments, in principle, identical members are identified by identical reference numbers and duplicate descriptions of them are omitted.

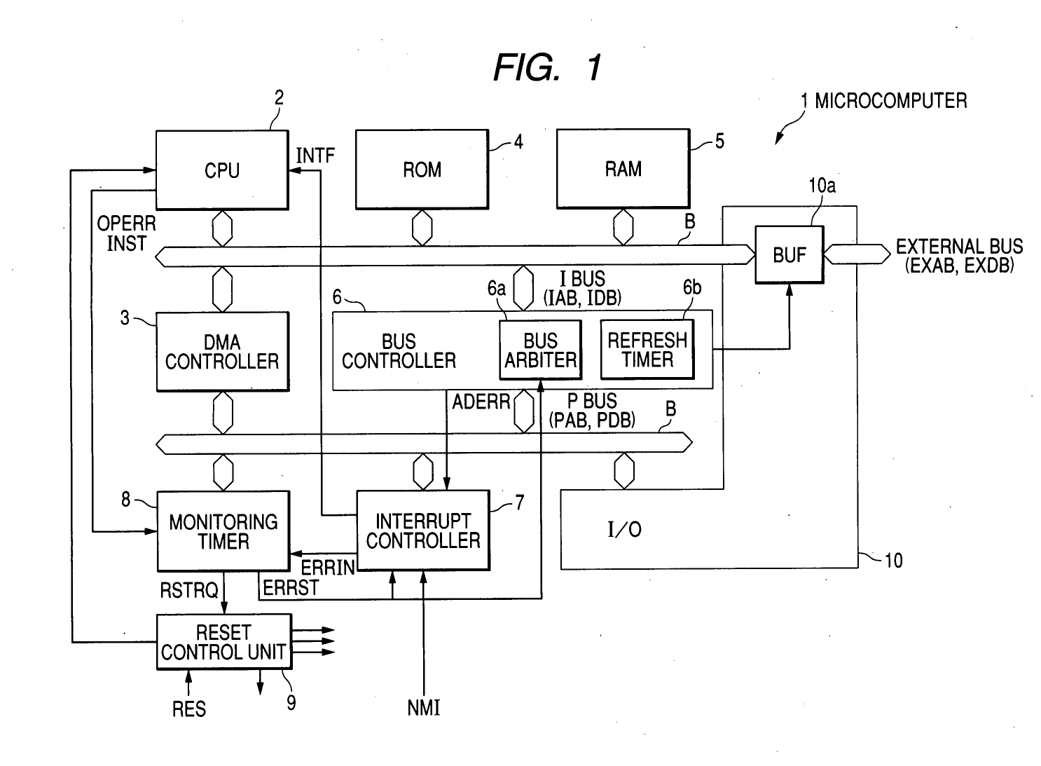

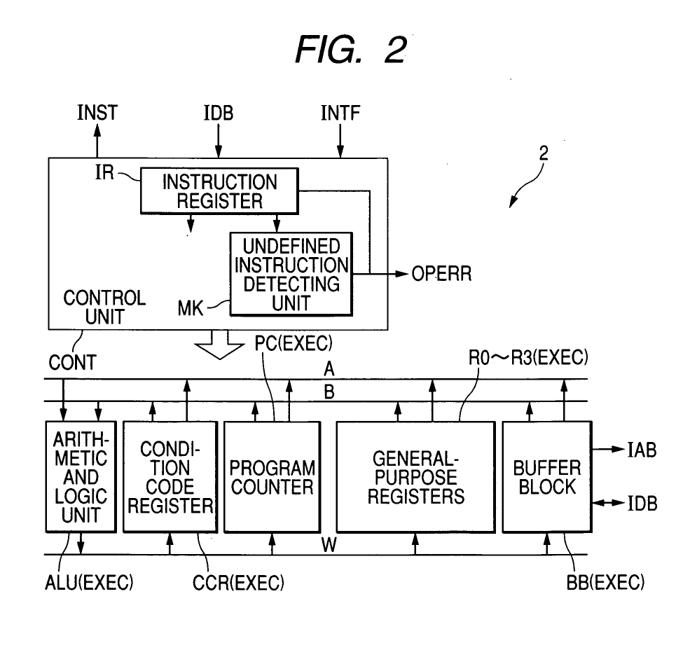

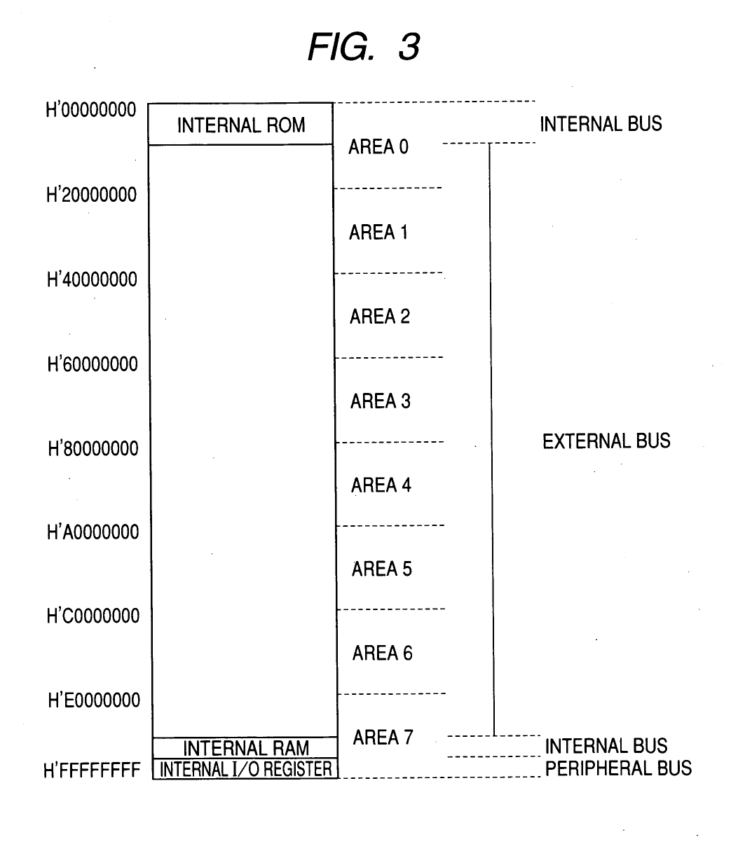

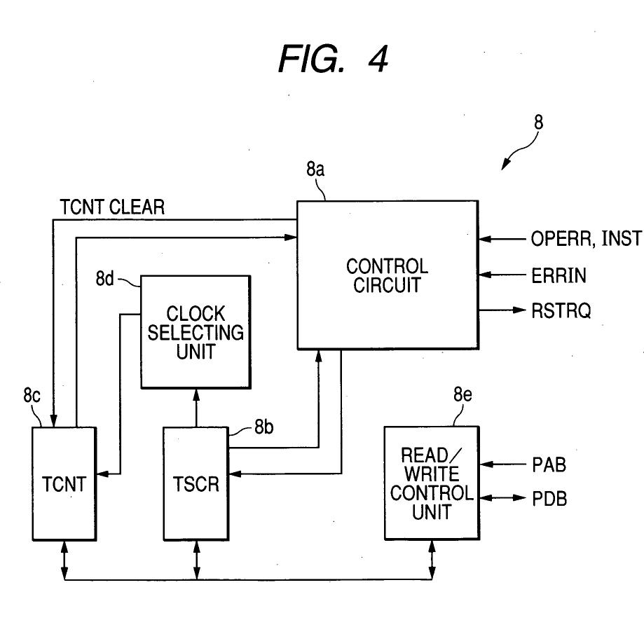

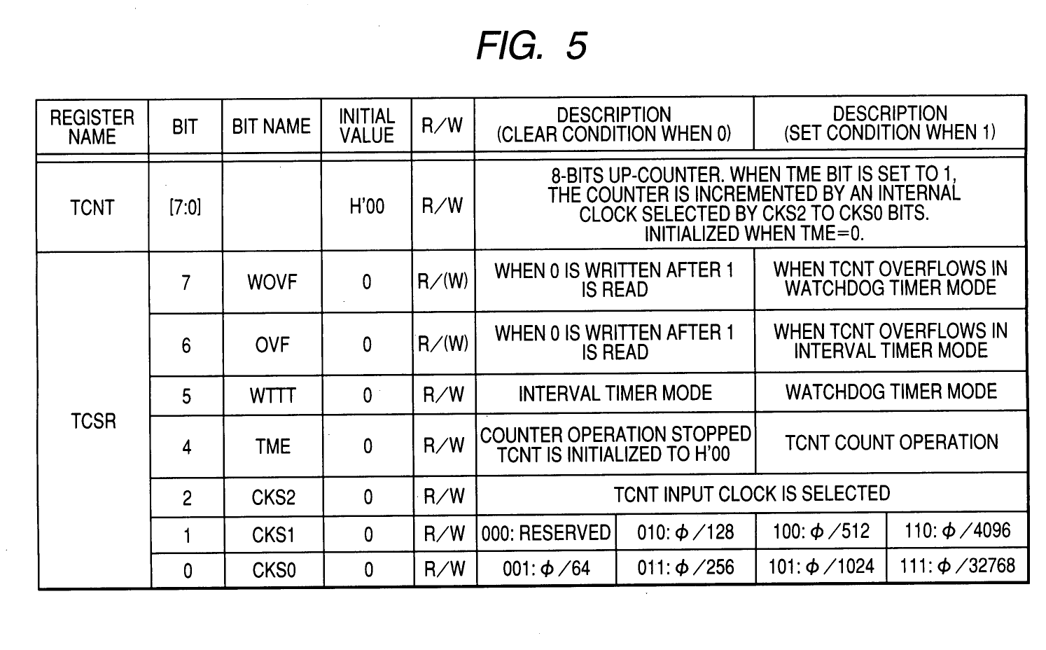

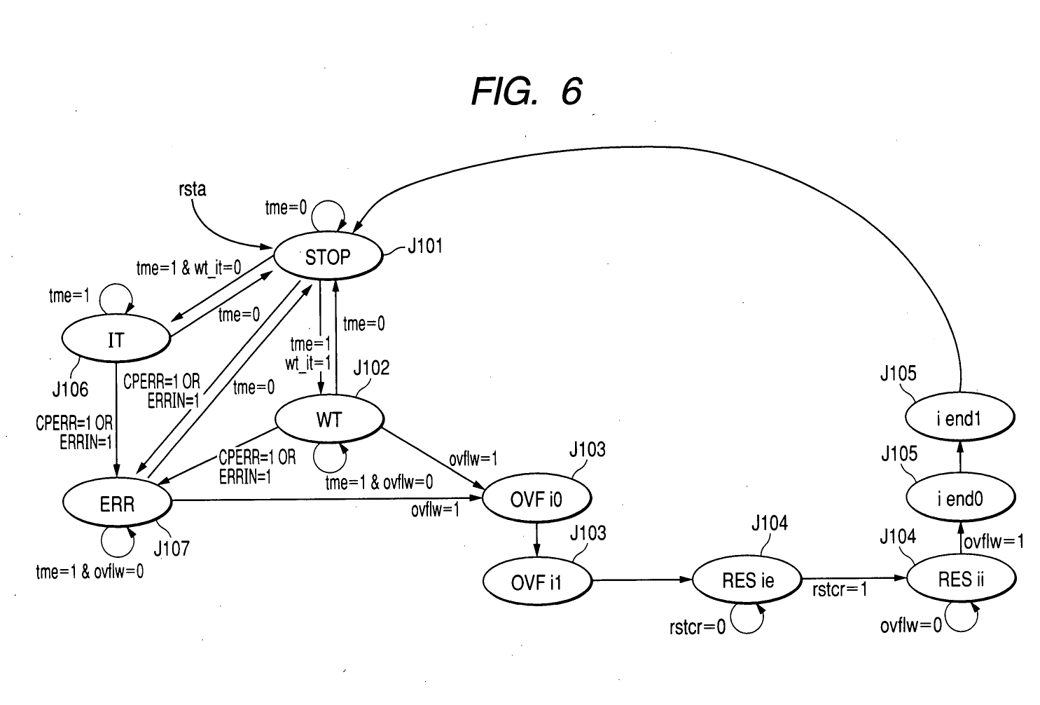

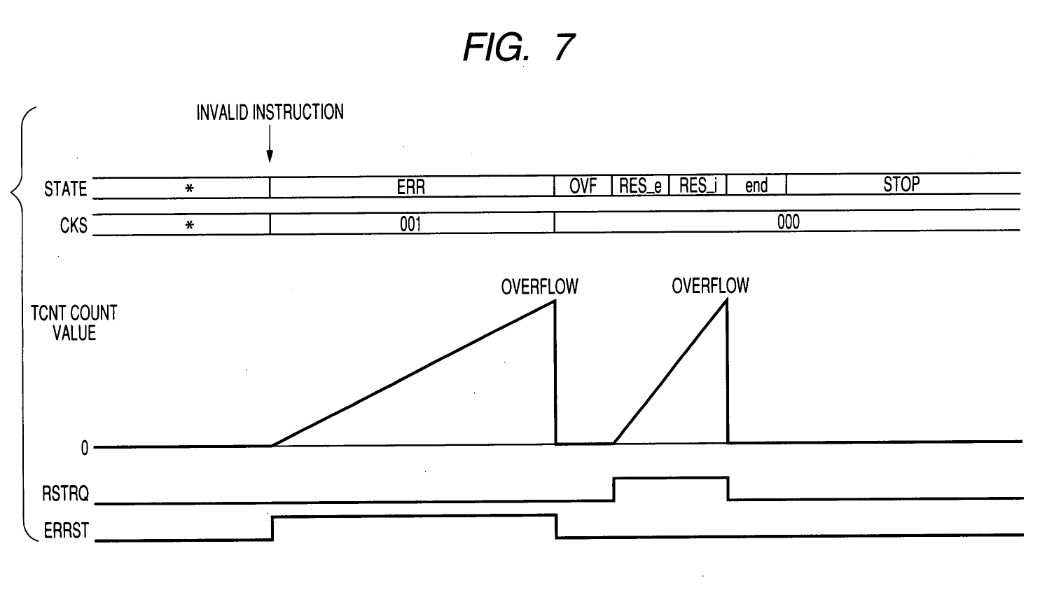

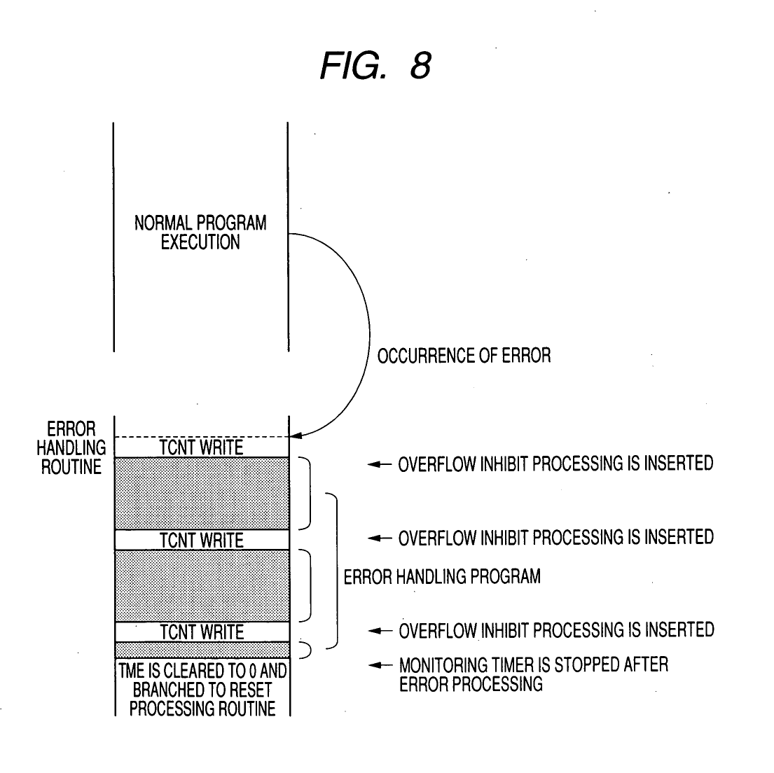

FIG. 1 is a block diagram of a microcomputer according to one embodiment of the present invention. FIG. 2 is a block diagram of a CPU mounted in the microcomputer of FIG. 1. FIG. 3 is an explanatory drawing showing an address space in the CPU 2 shown in FIG. 2. FIG. 4 is a block diagram showing the configuration of a monitoring timer mounted in the microcomputer of FIG. 1. FIG. 5 is an explanatory drawing showing an example of the configurations of a timer control register in the monitoring timer of FIG. 4, and a timer counter register. FIG. 6 is a drawing showing state transition in the monitoring timer of FIG. 4. FIG. 7 is a timing chart in the monitoring timer of FIG. 4. FIG. 8 is an explanatory drawing showing an example of error processing in the microcomputer of FIG. 1.

In the first embodiment, as shown in FIG. 1, a microcomputer (semiconductor integrated circuit) 1 comprises a CPU (central processing unit) 2, DMA (Direct Memory Access) controller 3, ROM 4, RAM 5, bus controller 6, an interrupt controller 7, a monitoring timer 8, a reset control unit 9, and I/O (Input/Output) 10. These are formed on one semiconductor substrate to form a single-chip microcomputer.

The I/O 10 comprises functional blocks or modules such as a timer, a pulse output circuit, a serial communications interface, an A/D converter, an input-output port, and a clock oscillator (CPG), and includes a reset input terminal and an interrupt input terminal.

A main portion of operation is the CPU 2, which reads instructions from the ROM 4, and reads from or writes to the RAM 5 as a work data area. Program memories of the CPU 2 may be a cache memory besides the ROM 4. Likewise, a cache memory may be used as a data memory of the CPU 2.

The CPU 2 detects an instruction to be executed, and when the instruction is not defined, detects it as an illegal instruction, activates an OPERR signal and performs predetermined exception handling.

The bus controller 6 detects the content of access of the CPU 2, and for an illegal access, performs address error detection, activates an ADERR signal, and transmits it to the interrupt controller 7. An illegal access is, for example, read from or write to an area to which the memory is not connected.

The interrupt controller 7 inputs the above-described address error ADERR, nonmaskable interrupt request signal NMI, which is a nonmaskable interrupt inputted from the outside, and the like, and presents an interrupt request signal INTF to the CPU 2. The above-described address error is also treated as a nonmaskable interrupt. When the interrupt request is presented, the CPU 2 performs interrupt exception handling in the gap between instructions.

The CPU 2 stops processing being executed, by performing illegal instruction exception handling and the interrupt exception handling, and starts the execution of an exception handling routine from the address shown by a prescribed vector. It inhibits interrupt acceptance by an error status signal ERRST from the monitoring timer 8. This inhibits interference to the execution of error handling due to repeated exception handling.

The monitoring timer 8 can activate a reset request signal RSTRQ to request a reset. The reset causes the microcomputer 1 to be internally reset. Moreover, a reset signal can be outputted to the outside of the microcomputer 1.

The controller 3 shares a bus B with the CPU 2 and performs data transfer in place of the CPU 2. An I/O 10 and an input-output interface issue an activation request to the DMA controller 3.

When the DMA controller 3 performs data transfer upon receiving an activation request, an activation cause is cleared. The interrupt controller 7 may determine and clear the activation cause.

The bus B is described below.

The microcomputer 1 includes I bus, P bus, and an external bus, and the functional blocks are mutually connected by the these buses. The I bus, P bus, and external bus include a bus right request signal, a bus acknowledge signal, a bus command (or read signal, write signal, bus size signal), and a ready signal (or wait signal), in addition to an address bus and a data bus.

The I bus is directly connected to the CPU 2, the DMA controller 3 or other internal bus masters. The memory is also connected to the I bus to enable high speed access to the memory. Access to the memory is made in one state.

An internal I/O register included in the I/O 10 is connected to the P bus. The I bus and the P bus are separated from each other to achieve high speed operation by reducing loads on the I bus used primarily during program read of the CPU 2, and to achieve low power consumption by holding the status of the P bus when not used.

The CPU 2 accesses the internal I/O register connected to the P bus via the I bus and the bus controller 6. Access to the internal I/O register is made in two states. The buses are controlled by the bus controller 6.

An internal bus and an external bus are interfaced by the external bus buffer circuit (BUF) 10a provided in the I/O 10. The external bus buffer circuit 10a is included in the input-output port.

The internal bus and a peripheral bus are interfaced by the bus controller 6. The internal bus (I bus) is connected to the CPU 2, the DMA controller 3, the ROM 4, the RAM 5, the external bus buffer circuit 10a, and the bus controller 6.

The CPU 2 and the DMA controller 3 can use the internal bus (I bus) as an internal bus master, and a bus arbiter 6a arbitrates according to their respective bus right request signals. For this purpose, the CPU 2 and other bus masters output bus right request signals, and an arbitrating circuit of the bus controller 6 discriminates them to afford a bus right to a one appropriate internal bus master. In short, the CPU 2 and the DMA controller 3 exclusively use the I bus.

The internal bus master confirms that a bus right has been afforded, and outputs IAB (address) and a bus command to perform bus access. The bus arbiter 6a does not accept any bus right requests except those from the CPU 2 by an error status signal ERRST of the monitoring timer 8.

The bus controller 6 checks the content of IAB, and in the case of access to the memory, performs control by use of the I bus. In the case of access to the internal I/O register, it activates a peripheral bus controller, deactivates a bus ready signal, and puts the internal bus master into a wait state.

The peripheral bus (P bus) is connected to the bus controller 6, the DMA controller 3, and the monitoring timer 8, and the I/O 10.

The external bus, which is connected to the external bus buffer circuit 10a, can be connected to a synchronous DRAM and the like connected to the outside of the microcomputer 1. It performs control such as address multiplexer when the synchronous DRAM is connected.

External bus masters that can use the external bus include internal bus masters, a refresh timer 6b, and external bus right requests, which are arbitrated by the bus arbiter 6a. The refresh timer 6b generates a refresh request at fixed intervals.

For example, when the refresh timer 6b acquires a bus right, as a refresh of the synchronous DRAM, it performs CAS (column address strobe) before RAS (row address strobe).

When an external bus right request acquires an external bus right, it puts an external bus (address bus, data bus, and control signal) into a high impedance state, enables use of an external bus by an external bus master, activates an external bus right acknowledge signal, and reports it.

The DMA controller 3 can output a bus right request to the internal bus. When making a bus right request, it inputs an internal bus right acknowledge signal, and upon confirming the acquisition of the internal bus right, issues an internal bus command and an address to perform internal bus access. Peripheral buses and external buses can be used via the internal bus.

The CPU 2 can request a bus right from the internal bus, and can use peripheral buses and external buses via the internal bus.

By the CPU 2 or the DMA controller 3, the ROM 4 and the RAM 5 are read and written as internal bus slaves, and functional blocks of the I/O 10 and the input-output interface are read and written as peripheral bus slaves. The DMA controller 3 is read and written as a peripheral bus slave by the CPU 2 to perform its settings.

Other functions of the microcomputer 1 will be briefly described below.

The interrupt controller 7 inputs an interrupt signal outputted by I/O or the input-output interface, and outputs an interrupt request signal to the CPU 2. The input-output port is shared with external bus signals (address bus output, data bus input/output, and bus control signal input/output), and input/output signals of the I/O 10.

Other input terminals include power terminals Vcc and Vss, analog power terminals AVcc and AVss, standby input STBY, clock inputs EXTAL and XTAL, and operation mode inputs MD0, MD1, and MD2.

FIG. 2 is a block diagram showing the configuration of the CPU 2.

The CPU 2, as shown in the drawing, comprises a control unit CONT and an execution unit EXEC.

The execution unit EXEC includes general-purpose registers R0 to R31, program counter PC, a condition code register CCR, an arithmetic and logic unit ALU, and a buffer block BB.

These are mutually connected by a read bus A/B and a write bus W. The buffer block is an address buffer or a data buffer.

The control unit CONT includes an instruction register IR that inputs the content of the data bus, and an undefined instruction detecting unit MK. The content of the instruction register IR is decoded in the control unit CONT, and control signals to the execution unit EXEC and bus control signals are generated. At termination of one instruction, the control unit activates an instruction execution end signal INST.

The undefined instruction detecting unit MK decodes the content of the instruction register IR, and determines whether the instruction is a defined instruction. If the instruction is an undefined instruction, an illegal instruction detection signal OPERR is activated. This is reported to the monitoring timer 8, the content of the instruction register IR is changed to an instruction code corresponding to illegal instruction exception handling, and the execution of illegal instruction exception handling is started.

FIG. 3 is explanatory drawing showing an address space in the CPU 2 shown in FIG. 2.

The address space of the CPU 2 has, for example, 4 G bytes, and is split into eight areas. These areas are allocated to each have a bus width and the number of access states independently of each other by settings of the bus controller 6 (FIG. 1), and are controlled by an external bus controller.

On the other hand, the ROM 4, RAM 5, and internal I/O register in the microcomputer 1 operate with a bus width and the number of access states that are specific to them, regardless of the setting of the bus controller 6.

As described previously, the ROM 4 and the RAM 5 are connected through the internal bus (I bus), and are read and written in one state. The internal I/O register is connected to the peripheral bus (P bus), and is read and written in two states.

When a program is read from an internal I/O register area, or a program is read from other than the ROM 4 or RAM 5 in a single chip mode, the bus controller 6 activates an address error signal ADERR as an address error, and requests an interrupt from the interrupt controller 7 (FIG. 1). A detailed description of address error detection is omitted here because it is well-known.

FIG. 4 is a block diagram showing the configuration of the monitoring timer 8. FIG. 5 is an explanatory drawing showing an example of the resistor structure of the timer control register 8b and the timer counter 8c in the monitoring timer 8.

The monitoring timer 8 includes a control circuit 8a, a timer control register (TSCR) 8b, a timer counter (TCNT) 8c, a clock selection unit 8d, and a read/write control unit 8e.

The timer control register 8b and the timer counter 8c can be read and written through the P bus. However, to prevent their contents from being easily rewritten, the read/write control unit 8e performs control so that data to be written is written after writing a predetermined keyword in advance. This will not be described in detail because it is not directly related to the present invention.

The monitoring timer 8 inputs an illegal instruction detection signal OPERR from the CPU 2 and an error interrupt detection signal ERRIN from the interrupt controller 7.

The timer counter 8c counts a specified time. In an error condition described later, the timer counter 8c is cleared by the instruction execution end signal INST of the CPU 2. The timer counter 8c has eight bits although there is no particular limitation. A count-up clock of the timer counter 8c is a signal obtained by dividing the frequency of a system clock φ selected by CKS bits of the timer control register 8b, and is supplied from the clock selection unit 8d.

When bits WTIT and TME of the timer control register 8b are set to 1, the monitoring timer operates and the timer counter 8c performs count-up operation.

When the timer counter 8c overflows, the timer requests a reset. When a reset is requested, a bit WOVF is set to 1. The CPU 2 can determine the cause of reset by checking the flag by a reset processing routine.

As long as the CPU 2 operates normally, it writes 0 to the timer counter 8c before the timer counter 8c overflows, thereby inhibiting an overflow. When the CPU 2 has become unable to operate normally, the monitoring timer 8 overflows to perform a reset. The reset causes the microcomputer to be reset, and the reset signal can also be outputted to the outside.

The monitoring timer 8 is stopped after the reset although there is no particular limitation. The CPU 2 performs settings for the timer control register 8b of the monitoring timer 8 to activate it. When the illegal instruction, address error, or nonmaskable interrupt request signal is requested, the monitoring timer 8 is forcibly started to operate.

The following describes the action of the monitoring timer 8 in the present embodiment.

FIG. 6 is a drawing showing a state transition of the monitoring timer 8. The state transition in FIG. 6 is achieved by a logic of a control block of the monitoring timer 8.

After a reset, the monitoring timer 8 is in stop state STOP (state J101). When bits WTIT and TME (FIG. 4) are set to 1, respectively, transition to the watchdog timer mode WT (FIG. 4) is performed (state J102).

When the timer counter 8c overflows in this state (state J103), transition to a reset request state RES is performed (state J104), bits CKS is set to a fixed value, predetermined counting is performed, and a reset request is outputted. In this state J104, to make reset requests to the outside shorter than reset requests to the inside, the reset request state may be divided into plural states.

After that, through a reset end state END (state J105), the monitoring timer 8 itself is initialized and returns to STOP state (J101). When it operates in an interval timer mode (FIG. 4), transition to the interval timer mode IT is performed (state J106).

When the above-described illegal instruction, address error, or nonmaskable interrupt request signal is requested, transition to the error detection state ERR is performed from any of states J101, J102, or J106 (state J107).

In this state, the error status signal ERRST is presented to the interrupt controller 7 and the bus arbiter 6a of the bus controller 6 to give precedence to error handling of the CPU 2. Bits CKS are set to a fixed value. When the timer counter 8c overflows in this state, the monitoring timer 8 outputs a reset request as in the above-described case.

When clearing the timer counter 8c by the instruction execution end signal INST of the CPU 2, it is advisory to specify a count-up clock by bits CKS so that it is relatively small.

The timer counter 8c may be cleared by program execution of the CPU 2, not by the instruction execution end signal INST of the CPU 2. In this case, it is advisory to specify a count-up clock by bits CKS so that it is relatively large.

When the CPU 2 cannot correctly perform error handling after error detection, a reset may be generated for initialization. For example, the CPU 2 may not correctly perform error handling because it cannot acquire a bus right due to successive requests from the DMA controller 3 or the refresh timer 6b, or successive external bus right requests.

If combinations of internal I/O registers are changed to illegal combinations due to an error, the hardware may not operate correctly, and interrupt requests and the like may be fixed to an activation state.

The operation of the monitoring timer 8 will be described with reference to a timing chart of FIG. 7.

FIG. 7 shows, from the top to the bottom, states outputted from the CPU 2, bits CKS (FIG. 4), a count value of the timer counter 8c, and signal timings of the reset request RSTRQ outputted from the monitoring timer 8, and the error status signal ERRST outputted from the monitoring timer 8.

When the monitoring timer 8 is in STOP state, watchdog timer mode WT, or interval timer mode IT, and the illegal instruction detection signal OPERR is set to 1 as a result of error detection, the monitoring timer 8 performs transition to ERR state and activates the error status signal ERRST.

Bits CKS, although there is no particular limitation, are set to 001 (φ/64 (FIG. 4)) to start count-up. When the timer counter 8c is eight bits, if the CPU 2 makes no write to the timer counter 8c within 2048 (256×8) states, the monitoring timer 8 is in a RES state, and activates the reset request RSTRQ to reset the microcomputer 1. The time is measured by setting bits CKS to 000 and waiting that the timer counter 8c overflows. Then, transition to STOP state is performed.

The error handling routine of the CPU 2 contains an instruction that writes zero to the timer counter 8c in an interval not extending the 2048 states. It contains processing that stops the monitoring timer 8 on completion of error handling.

The following describes an example of the operation of the above-described error handling with reference to FIG. 8.

When an error occurs (a lower portion of FIG. 8, error handling routine) in a normal program execution state (upper portion of FIG. 8), processing of the CPU 2 branches to a predetermined error handling routine shown by exceptional handling vectors or the like.

While executing the instruction that writes zero to the timer counter 8c in an interval not extending an overflow cycle, the error handling routine of the CPU 2 performs processing for inhibiting a fatal operation in accordance with a control target system. An example of inhibiting a fatal operation is to deactivate output signals of the microcomputer 1.

Since bus right requests and interrupt requests of the DMA controller 3 are inhibited by signals outputted from the monitoring timer 8, these processings can be made needless by performing the error handling routine.

On completion of the error handling, bit TME is cleared to zero, the monitoring timer 8 is stopped, and the processing of the CPU 2 is changed to a normal reset processing routine. Alternatively, instead of stopping the monitoring timer 8, by intentionally generating an overflow by writing a maximum value to the timer counter 8c, the microcomputer 1 may be reset. Undesirable states within the microcomputer 1 can be cleared by the reset.

Thereby, according to the present embodiment, effects described below can be obtained.

(1) By starting the monitoring timer 8 upon detecting an error, even when the CPU 2 cannot correctly perform error handling, the system can be restored by being initialized by a reset. In this case, an overflow cycle of the monitoring timer 8 can be shortened to improve monitoring accuracy.

(2) After being started, the monitoring timer 8 can be returned to its initial state by processing of the CPU 2, so that the processing of the CPU 2 can be continued.

(3) By monitoring internal signals of the CPU 2, it can be immediately recognized that the CPU 2 cannot correctly perform error handling, so that the system can be restored by being initialized by a reset.

(4) By sharing the monitoring timer as a user resource, effective use of resources can be achieved.

(5) The monitoring timer 8 removes factors to interfere with CPU 2 error handling such as bus right and interrupts, thereby eliminating the need to perform processing for stopping the DMA controller 3 in an error handling routine.

(6) In other words, when an error occurs, urgent processing can be performed by the CPU 2 before a reset is generated after a fixed time. Error handling is performed in two stages so that it can be performed more surely. An attempt can be prevented to intentionally cause malfunction by an error to obtain internal information.

Hereinbefore, though the invention made by the inventors of the present invention has been described in detail based on the preferred embodiments, it goes without saying that the present invention is not limited to the preferred embodiments, but may be modified in various ways without changing the main purports of the present invention.

For example, modes and register configuration of the monitoring timer can be freely changed. Although a monitoring timer of a user resource may be shared as described above, a dedicated function may be provided. Or sharing with a function such as a refresh timer is also possible.

Signals supplied from the CPU may be any signals to aid in determining instruction execution states of the CPU, in addition to the instruction execution end signal. Signals to indicate bus access states are also allowed. An overflow cycle at the occurrence of an error may be common to general selections or a dedicated cycle may be used.

Resets to the outside may be dispensable or optional. In any case, resets shorter than general selections are preferable. If an error occurs again in an error state, a reset request may be immediately generated. State transitions of the monitoring timer may be changed in various ways.

Error detection contents may be changed as required. Undefined instructions may be detected before or after their execution, and decoding may performed in any ways. The data transfer device is not limited to the DMA controller, and may be a coprocessor that requests a bus right.

The configuration of the microcomputer and the address space are not limited. Functional blocks may be changed in various ways.

Hereinbefore, the invention made by the inventors of the present invention has been described of application to a single-chip microcomputer being an application field of the present invention. However, the present invention, without being limited to it, may be applicable to other semiconductor integrated circuits such as semiconductor integrated circuits based on digital signal processors (DSP). The present invention can apply at least to a semiconductor integrated circuit that includes a data processing unit for executing programs.

The semiconductor integrated circuit of the present invention is suitable for technology for minimizing the influence of error-triggered malfunction.

What is claimed is:

1. A semiconductor integrated circuit comprising:
a central processing unit that detects an error, and branches to a predetermined processing routine; and
a monitoring timer that starts to count based on an error detection signal when the central processing unit detects an error,
wherein the monitoring timer requests a reset upon judging that the central processing unit does not execute processing corresponding to the detected error.

2. The semiconductor integrated circuit according to claim 1,
wherein errors detected by the central processing unit are at least one of an illegal instruction or an address error, and
wherein the error detection signal inputted to the monitoring timer is outputted from any one of the central processing unit, a bus controller, and an interrupt controller.

3. The semiconductor integrated circuit according to claim 1,
wherein the monitoring timer resets a count upon receiving an instruction execution end signal outputted at termination of an instruction from the central processing unit.

4. The semiconductor integrated circuit according to claim 1,
wherein the central processing unit controls a count of the monitoring timer by bus access.

5. The semiconductor integrated circuit according to claim 1,
wherein the monitoring timer outputs an error status signal to the bus controller when the central processing unit detects an error, and
wherein the bus controller does not accept bus right requests from other than the central processing unit upon receiving the error status signal of the monitoring timer.

6. The semiconductor integrated circuit according to claim 1,
wherein the interrupt controller does not output an interrupt request signal to the central processing unit when the central processing unit detects an error.
